(19) United States
(12) Patent Application Publication
(10) Pub. No.: US 2023/0122847 A1
(43) Pub. Date: Apr. 20, 2023

(54) ROLE-BASED SOCIAL NETWORK

(71) Applicant: AMI Holdings Limited, Hamilton (BM)

(72) Inventors: Ronen Benchetrit, London (GB); Tariq Masud Shaukat, Austin, TX (US)

(21) Appl. No.: 17/964,521

(22) Filed: Oct. 12, 2022

Related U.S. Application Data
(60) Provisional application No. 63/256,842, filed on Oct. 18, 2021.

(51) Int. Cl. G06V 10/764; G06Q 50/00

(52) U.S. Cl. CPC G06V 10/764; G06Q 50/01

(57) ABSTRACT

A first association between a first user of a social network and a first role held by the first user is stored, and a second association between a second user of the social network and a second role held by the second user is stored. An indication of a first type of role-based relationship between the first user and the second user is stored. A database storing a plurality of elements is queried, the querying including selecting, from the plurality of elements, a subset of elements that are associated with the first type of role-based relationship. The subset of elements are provided to a first client device associated with the first user, at least one of the subset of elements being for display in a graphical user interface of the first client device.

### CLAIM OF PRIORITY

This application claims priority under 35 USC § 119(e) to U.S. Patent Application Ser. No. 63/256,842, filed on Oct. 18, 2021, the entire contents of which are hereby incorporated by reference.

### FIELD OF THE DISCLOSURE

The present disclosure relates to social networks.

### BACKGROUND

Social networks facilitate interactions between users in various contexts, such as dating, professional recruiting and networking, and interest-based discussion.

### SUMMARY

In one aspect, the present disclosure describes a computer-implemented method. In the computer-implemented method, a first association between a first user of a social network and a first role held by the first user is stored, and a second association between a second user of the social network and a second role held by the second user is stored. The first role is different from the second role. A request is received to establish a first type of role-based relationship between the first user and the second user. The first type of role-based relationship is specific to the first role and the second role. An indication of the first type of role-based relationship between the first user and the second user is stored. A database storing a plurality of elements is queried. Each element of the plurality of elements is associated with one or more types of role-based relationships that are specific to roles of users in the role-based relationships, and the plurality of elements includes at least one of user interface elements, application features, operations performable by client devices or requestable by client devices to be performed at a remote server, user images, user statistics, or protected user data. The querying includes selecting, from the plurality of elements, a subset of elements that are associated with the first type of role-based relationship. The subset of elements are provided to a first client device associated with the first user, at least one of the subset of elements being for display in a graphical user interface of the first client device.

Another aspect of the present disclosure describes one or more tangible, non-transitory, computer-readable media. The computer-readable media store instructions that, when executed by a processing system, cause the processing system to perform operations. In the operations, a first association between a first user of a social network and a first role held by the first user is stored, and a second association between a second user of the social network and a second role held by the second user is stored. The first role is different from the second role. A request is received to establish a first type of role-based relationship between the first user and the second user. The first type of role-based relationship is specific to the first role and the second role. An indication of the first type of role-based relationship between the first user and the second user is stored. A database storing a plurality of elements is queried. Each element of the plurality of elements is associated with one or more types of role-based relationships that are specific to roles of users in the role-based relationships, and the plurality of elements includes at least one of user interface elements, application features, operations performable by client devices or requestable by client devices to be performed at a remote server, user images, user statistics, or protected user data. The querying includes selecting, from the plurality of elements, a subset of elements that are associated with the first type of role-based relationship. The subset of elements are provided to a first client device associated with the first user, at least one of the subset of elements being for display in a graphical user interface of the first client device.

Another aspect of the present disclosure describes a computer-implemented system. The computer-implemented system includes one or more computers and one or more computer memory devices interoperably coupled with the one or more computers and having tangible, non-transitory, machine-readable media storing one or more instructions that, when executed by the one or more computers, cause the one or more computers to perform operations. In the operations, a first association between a first user of a social network and a first role held by the first user is stored, and a second association between a second user of the social network and a second role held by the second user is stored. The first role is different from the second role. A request is received to establish a first type of role-based relationship between the first user and the second user. The first type of role-based relationship is specific to the first role and the second role. An indication of the first type of role-based relationship between the first user and the second user is stored. A database storing a plurality of elements is queried. Each element of the plurality of elements is associated with one or more types of role-based relationships that are specific to roles of users in the role-based relationships, and the plurality of elements includes at least one of user interface elements, application features, operations performable by client devices or requestable by client devices to be performed at a remote server, user images, user statistics, or protected user data. The querying includes selecting, from the plurality of elements, a subset of elements that are associated with the first type of role-based relationship. The subset of elements are provided to a first client device associated with the first user, at least one of the subset of elements being for display in a graphical user interface of the first client device.

Any of these aspects of the disclosure, or other aspects of the disclosure as described herein, may have any one or more of at least the following characteristics.

In some implementations, the subset of elements includes data associated with the second user, and the first user is excluded from obtaining the data associated with the second user in the absence of the first type of role-based relationship.

In some implementations, a trained image classification machine learning model is applied to a set of images associated with the second user. As an output of the trained image classification machine learning model, image classification labels are obtained for images of the set of images. Based on the image classification labels, an association is stored between a first image of the set of images and the first type of role-based relationship. The subset of elements includes the first image.

In some implementations, storing the association between the first image and the first type of role-based relationship is based on an object depicted in the first image.

In some implementations, the subset of elements includes a selectable user interface element.

In some implementations, subsequent to selecting the subset of elements, a user interface is generated including the selectable user interface element. The user interface is provided to the first client device for display on the first client device.

In some implementations, a social network profile of the second user is provided to the first client device and to a second client device associated with the second user. From the first client device, a proposed change to the social network profile is received. The proposed change is indicated on the first client device using a first element of the subset of elements. The social network profile modified to incorporate the proposed change is provided to the second client device. From the second client device, an indication of approval or disapproval of the proposed change is received.

In some implementations, it is determined that an image associated with the second user matches a predetermined criteria. Based on determining that the image associated with the second user matches the predetermined criteria, an association is stored between the image and the first type of role-based relationship. The image is provided to the first client device and to a second client device associated with the second user. The image is included in the subset of elements. A proposed change to the image is received from the first client device. The image is modified to incorporate the proposed change, to obtain a modified image. The modified image is provided to the first client device and the second client device.

In some implementations, the modified image is added to a profile page of the second user.

In some implementations, modifying the image includes modifying the image to incorporate a product proposed by the first user.

In some implementations, a third association is stored between the first user of the social network and a third role held by the first user. The first user holds the first role and the third role simultaneously. A request is received to establish a second type of role-based relationship between the first user and the second user. The second type of role-based relationship is specific to the third role and the second role. An indication is stored of the second type of role-based relationship between the first user and the second user. The second type of role-based relationship exists simultaneously with the first type of role-based relationship. From the plurality of elements, a second subset of elements are selected that are associated with the second type of role-based relationship. The second subset of elements are provided to the first client device.

In some implementations, prior to receiving the request, as inputs to a machine learning model, data of the first user, data of the second user, the first role, and the second role are provided. As an output of the machine learning model, a recommendation to establish the first type of role-based relationship between the first user and the second user is obtained. To at least one of the first user and the second user, the recommendation is sent to establish the first type of role-based relationship between the first user and the second user.

In some implementations, providing the subset of elements to the first client device includes initiating a live communication session between the first client device and a second client device associated with the second user.

In some implementations, the live communication session includes live video communication.

In another aspect, this disclosure describes another computer-implemented method. In the method, data is stored indicating a first relationship between a first user of a social network and a second user of the social network. A request is received to substitute a third user of the social network for the first user in the first relationship. From at least one of a second client device associated with the second user and a third client device associated with the third user, at least one corresponding approval of the request is received. In response to receiving the at least one corresponding approval, data is stored indicating a second relationship between the second user and the third user.

Implementations of this or other methods may have any one or more of at least the following characteristics.

In some implementations, storing the data indicating the second relationship includes initiating the second relationship at a stage matching a latest stage of the first relationship.

In some implementations, the latest stage of the first relationship includes an initial stage, and the method includes providing, to the second client device, a user interface configured to be used to approve or disapprove the second user.

In some implementations, the latest stage of the first relationship includes an approved stage, and the method includes at least one of: enabling network communications between the second user and the third user, or providing, to the second client device associated with the second user, private data of the third user that is inaccessible to the second user in the absence of an approved match between the second user and the third user.

In some implementations, the network communications between the second user and the third user are enabled, and the network communications include live video communication

In some implementations, in response to receiving the at least one corresponding approval, data is stored indicating a cancellation of the first relationship.

In some implementations, the first relationship includes a first role-based relationship specific to a first role held by the first user and a second role held by the second user, and the method includes, prior to receiving the request to substitute the third user. querying a database storing a plurality of users. Each user of the plurality of users is associated with one or more respective roles held by the user, and the querying includes selecting, from the plurality of users, a subset of users that hold the first role. The method includes providing for selection, to a first client device associated with the first user, the subset of users.

Implementations according to this disclosure can provide various advantages. For example, in some implementations, provision of elements is linked to particular roles or role-based relationships, which can decrease computational resource consumption and network transmission burdens. In some implementations, the interactions facilitated by the described role-based processes facilitate improved social matching/interaction efficiency and reduce search space for matching.

The details of one or more implementations are set forth in the accompanying drawings and the description below. Other aspects, features and advantages will be apparent from the description and drawings, and from the claims.

### BRIEF DESCRIPTION OF THE DRAWINGS

FIG. 1 illustrates an example social network.

FIG. 2 illustrates an example social network.

FIGS. 3A-3D illustrate example user profiles.

FIGS. 4A-5B illustrate example user interactions.

FIG. 6 illustrates an example of image provision.

FIG. 7 illustrates an example user interaction.

FIG. 8 illustrates an example shopping interface.

FIG. 9 illustrates an example user interaction.

FIG. 10 illustrates an example of element provision.

FIGS. 11A-11B illustrate an example of match substitution.

FIGS. 12-13 illustrate example processes.

### DETAILED DESCRIPTION

This disclosure relates to a role-based social network. Each user of the social network can be associated with one or more roles, and relationships between these roles define displayed interface elements, cooperative profile and image viewing and editing through synchronized user interfaces, and other user interactions.

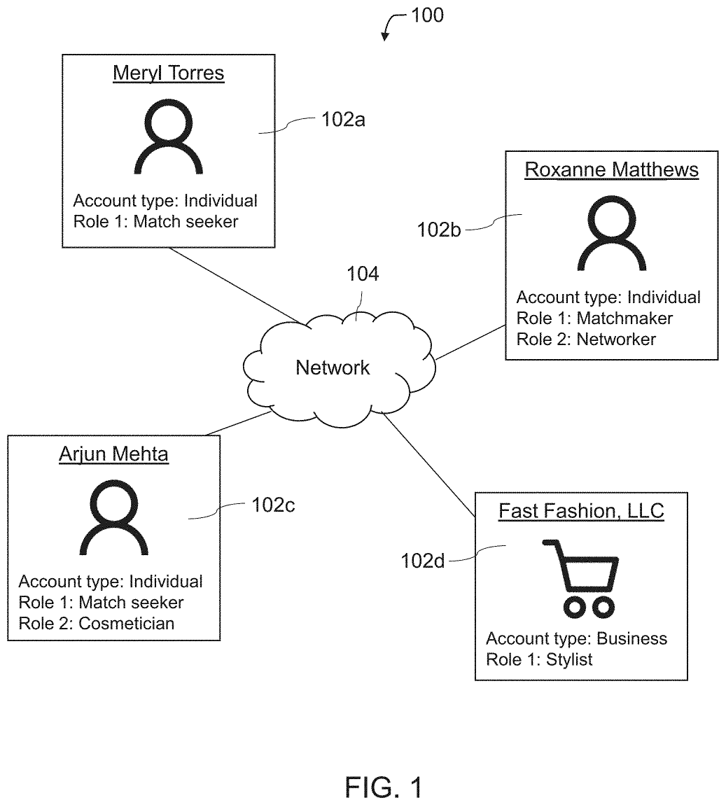

FIG. 1 illustrates a role-based social network 100 including multiple users 102a, 102b, 102c, 102d. The users 102a, 102b, 102c, 102d are linked by network and interaction elements 104 such as remote servers, cloud-based systems, mobile communication networks, and the Internet.

Users 102a, 102b, 102c are “individual” accounts that are associated with particular people who have registered with the social network. User 102d is a “business” account associated with a company (in this example, an apparel company). Other account types may also be included in the social network 100. For example, a “non-profit” account type may be associated with an advocacy group or charity.

Various types of social network 100 are within the scope of this disclosure. In some implementations, the social network 100 is a dating network. For example, the social network 100 may include user profiles and allow users to match with one another in a user-directed fashion (e.g., by swipe-based approval or disapproval), in an automated fashion (e.g., by automatic matching of compatible users), or in a combination of these ways. In some implementations, the social network 100 is a social network that includes non-dating matching and interaction. For example, the social network may include matching and discussions based around topics of common interest, such as politics and hobbies. The social network may be a “friend”-focused network in which non-romantic matching is included or emphasized. In some implementations, the social network 100 is a professional network that connects workers with one another and with businesses. Workers can list their work history, qualifications, and professional interests, recommend one another for open job positions, be recruited by interested companies, and share interesting commercial articles and comments. These and other social network types can also be combined together. For example, one social network may include both dating and non-dating interaction options, while another social network may combine professional networking with hobby-focused discussions.

Each user 102a, 102b, 102c, 102d is associated with one or more “roles.” On a more granular level than account type, these roles determine the space of operations and interactions available to each user. The social network 100 is “role-based” in that the possible interactions between users are at least partly determined by the respective roles of the users and by the role-based relationships established between them. For example, a given type of interaction may be enabled between role A and role B but disabled between role A and role C. These interactions are represented by role-based relationships defined by the respective roles of the users in the relationships.

In the example of FIG. 1, user 102a has a single role, “match seeker,” indicating that user 102a is interested in using the social network 100 to meet potential partners for dates. When user 102a interacts with other users in the social network 100, the expressions of those interactions are determined by the role-based interactions between the role type “match seeker” and role types of the other users. For example, user 102a may be able to review public profiles of other match seekers and choose to connect to those users through interactions (chat, video, etc.) mediated by the network and interaction elements 104. An agreed-upon matching between user 102a and another match seeker establishes a role-based relationship between the two users, the role-based relationship being of the match seeker-match seeker type.

User 102b has two roles, “matchmaker” and “networker.” The “matchmaker” role indicates that user 102b can enter into matchmaking relationships with match seekers in the social network 100. As described in more detail below, the matchmaking-type role-based relationship allows user interactions including expanded data access and synchronized matchmaking sessions. The “networker” role indicates that user 102b can enter into networking-type role-based relationships with other networkers and with recruiters.

User 102c also has two roles, “match seeker” and “cosmetician.” “Match seeker” allows for dating interactions, as described for user 102a. “Cosmetician” indicates that user 102c can form beauty consulting and/or supply relationships with match seekers, matchmakers, stylists, and other role types. These relationships are role-based relationships that enable interactions defined by the respective other role type, meaning that the interactions allowed by a cosmetician-match seeker relationship may be different from those allowed by a cosmetician-matchmaker relationship.

User 102d's role is “stylist,” indicating that user 102d can enter into apparel consulting and/or supply relationships with match seekers, matchmakers, cosmeticians, and other role types. As for the cosmetician role, these role-based relationships need not be the same regardless of the role type of the other user interacting with the stylist, but rather can vary in form and scope depending on the role of the other user. In addition, user 102d has the account type “business,” indicating that user 102d is associated with a business (e.g., an apparel store or marketplace) rather than with an individual. For example, user 102d can be managed by employees of the business “Fast Fashion, LLC.” Significant flexibility is available for combinations of roles and account types, such that most roles are compatible with most account types. For example, a makeup company may be a user with the role “cosmetician” and account type “business,” while an independent style consultant may be a user with role “stylist” and account type “individual.” Some roles may be particular to some account types. For example, the role “match seeker” may be restricted to individual-type accounts.

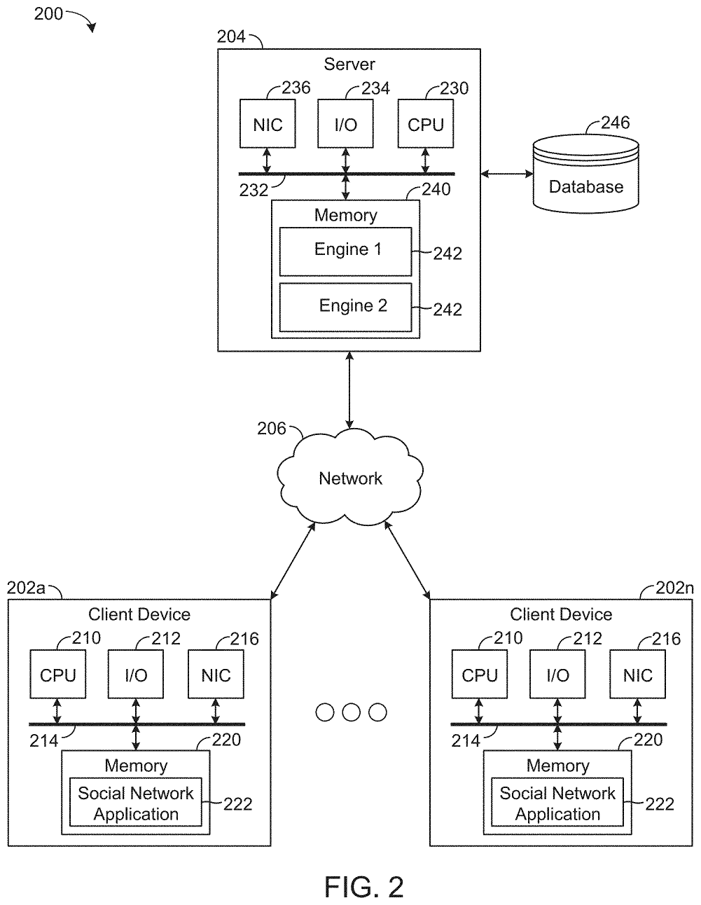

FIG. 2 illustrates a system 200 for role-based interactions in a social network. The system 200 includes a plurality of client devices 202a through 202n in communication with a server 204 (which may represent multiple servers in communication with one another) via a network 206, which may be a wired or wireless network or any combination thereof. Each client device 202a through 202n (referred to collectively as client devices 202) includes one or more processors (e.g., central processing unit) 210 in communication with input/output devices 212 via a bus 214. The input/output devices 212 can include a touch display, keyboard, mouse, and the like. A network interface circuit 216 is also connected to the bus 214 to provide wired and/or wireless connectivity to the network 206. A memory or other storage medium 220 is also connected to the bus 214. The memory 220 stores instructions executed by the processor 210. In particular, the memory 220 stores instructions for a social network application 222, such as a dating application, which communicates with server 204 to coordinate interactions between users. In some implementations, each client device 202 is a mobile device (e.g., smartphone, laptop, tablet, wearable device, etc.) executing the social network application 222. Different client devices 202 are operated by different users that subscribe to the same social network application 222.

The server 204 includes one or more processors 230, bus 232, input/output devices 234 and a network interface circuit 236 to provide connectivity to the network 206. A memory 240 is connected to the bus 232. The memory 240 stores one or more engines 242 with instructions executed by the processor 230 to implement role-based operations. In some implementations, the system 200 includes one or more databases 246 in communication the server 204 that stores information for use by the social network application 222 and/or the engines 242, user profile information, match information, message information, elements and associated role-related information, or other information.

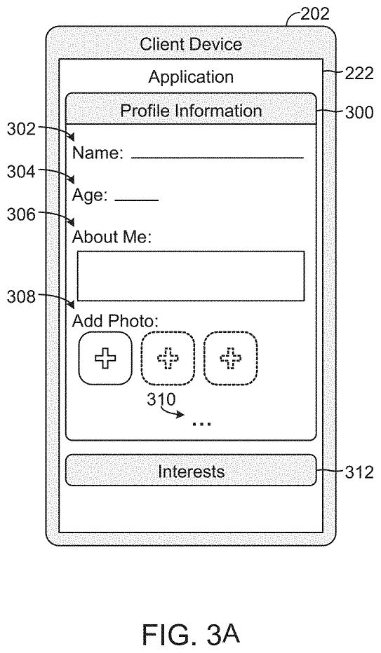

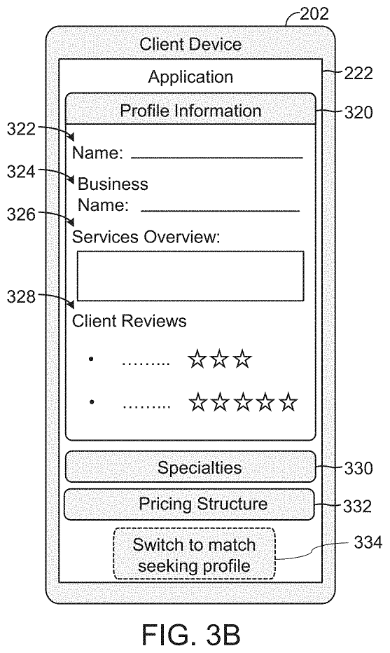

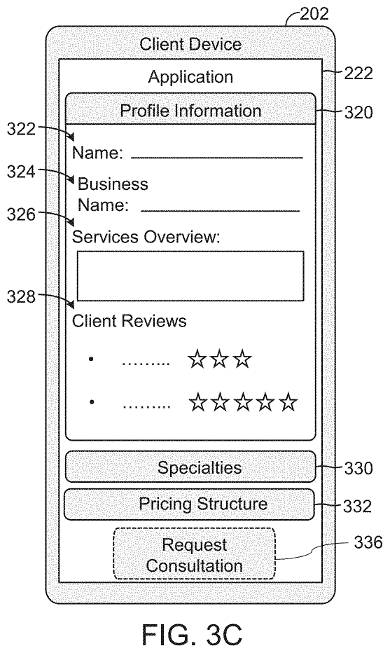

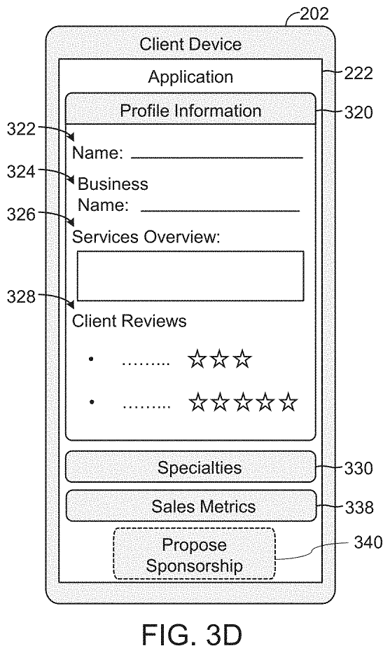

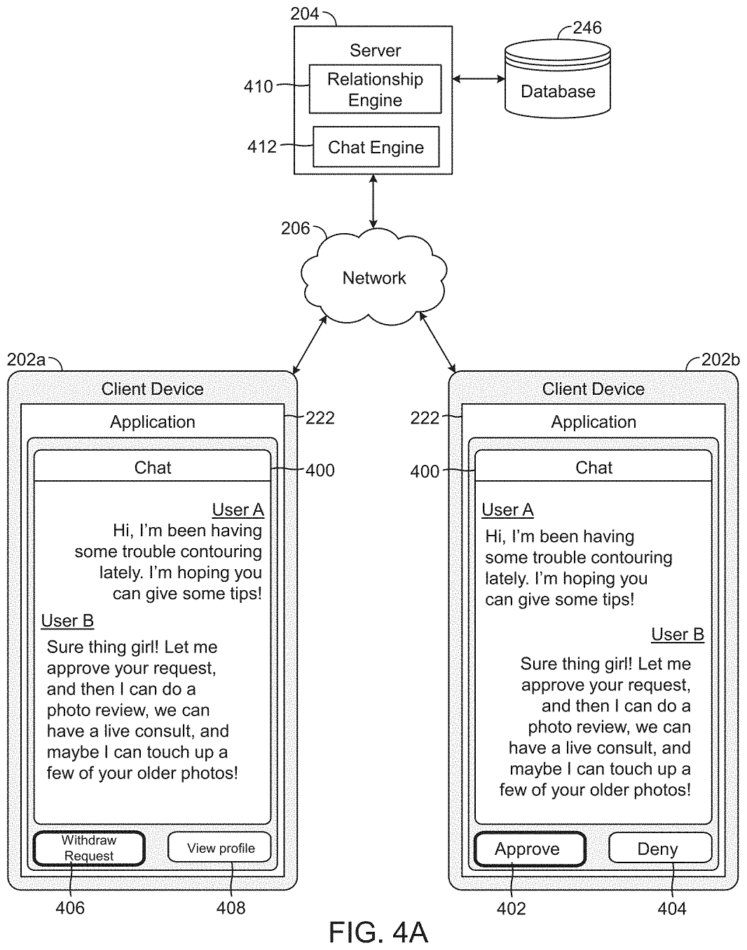

In operation, a user of a client device 202 can create a profile to participate in the social network application 222. The form and content of the profile will depend on the one or more roles assigned to the user. For example, referring to FIG. 3A, a user with the role “match seeker” can create a personal dating profile by interacting with a user interface to provide profile information, such as their name 302, age 304, biographical text 306, photographs 308, and a range of other fields 310 (e.g., city, links to social media profiles on other networks, astrological sign, etc.) that allow the user to characterize themselves. Each user can also specify their interests 312 for use in identifying potential matches.

FIG. 3B shows an example profile for a user with another role, such as matchmaker, stylist, or cosmetician. The profile information 320 is different from that associated with the match seeker role and includes information including name 322, business name 324, an overview of services provided 326, and client reviews 328. Interface elements 330 and 332 are selectable to view a list of service specialties or a pricing structure for use of those services. And, because some users may hold multiple roles, an interface element 334 can allow for switching between viewing a service provider profile, such as the matchmaker, stylist, or cosmetician profile 320 shown in FIG. 3B, and a personal profile such as the match seeker profile 300 shown in FIG. 3A. In some cases, the element 334 may be exposed only to the user corresponding to the profile 320, so that other users cannot at will view the user's dating profile based on their service provider profile.

The form and content of a given profile may depend not only on the role associated with the profile, but also on the role of another user viewing the profile. Different types of information and different types of interactions will tend to be more relevant for different roles, and the profile can be adapted accordingly. For example, as shown in FIG. 3C, a match seeker viewing the profile 320 (e.g., a profile for a role other than a match seeker, such as a matchmaker, stylist, or cosmetician) is shown a user interface element 336 that allows the match seeker to request a role-based relationship with the service providing user corresponding to the profile 320. The request may take various forms. In some implementations, when the element 336 is selected, a pre-set request message is sent to the service providing user. For example, the service providing user may receive a notification that “Meryl Tones would like to hire you to be her matchmaker!” Alternatively, or in addition, selection of the element 336 may open a communication channel such as a text chat, a videoconference, or a phone call between the two users, allowing them to discuss the possible services to be provided and the terms of the possible role-based relationship.

As shown in FIG. 3D, a stylist or cosmetician viewing the profile 320 is shown an interface element 338 that allows the stylist or cosmetician to view sales metrics of the service providing user corresponding to the profile 320. For example, if the service providing user is a profile consultant, the stylist or cosmetician may be permitted to review a number of recent clients of the profile consultant, a number of in-application sales initiated by the profile consultant during profile editing consultations, and other data relevant to a possible relevant commercial relationship.

If the stylist or cosmetician viewing the profile 320 would like to request a role-based relationship with the service providing user, they can select interface element 342 and initiate a relationship request process as described in reference to FIG. 3C. The interactions allowed by the role-based relationship depend on the roles of the users in the relationship. For example, a stylist may request a sponsoring role-based relationship with a matchmaker, through which the matchmaker can recommend the stylist's consulting services to clients of the matchmaker in exchange for a percentage of the fees for the consultations.

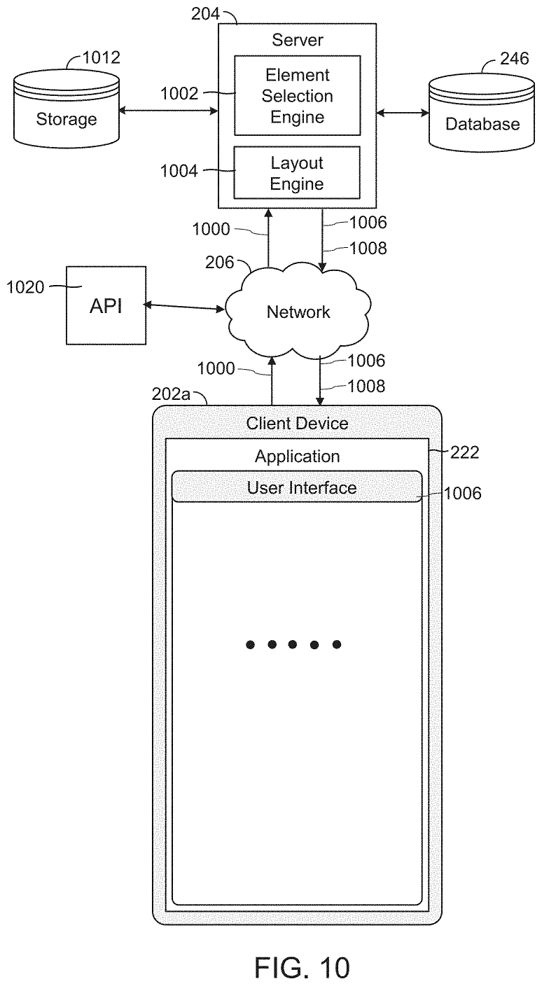

The different forms of the profile 320 shown in FIGS. 3B-3D, and the different functions and interactions associated with the different profiles, can be facilitated by role-dependent provision of the profile 320. For example, the interface element 338 and its associated function of viewing the sales metrics of the service providing user may be elements associated with particular roles and/or role-based relationships. When the profile 320 is requested, the interface element 338 and its associated function are provided or not provided depending on the role of the requesting user and/or depending on any role-based relationships formed between the requesting user and the service provider corresponding to the profile 320. In some implementations, this selective provision is facilitated by systematic association of social network elements with certain roles and/or role-based relationships. Further details on this configuration of the social network are described in reference to FIG. 10.

Role-based relationship requests can be confirmed or rejected by a target of the request. When a first user requests to form a role-based relationship with a second user, the second user is provided with response options, e.g., agreeing to the relationship, rejecting the relationship, initiating a communication channel with the first user, and/or blocking the first user. While some role-based relationships may be free for both users (e.g., dating match relationships between two match seekers), others may require payment to a service providing user. Payment details can be input when the relationship is established and/or may be imported from existing payment details stored by the social network.

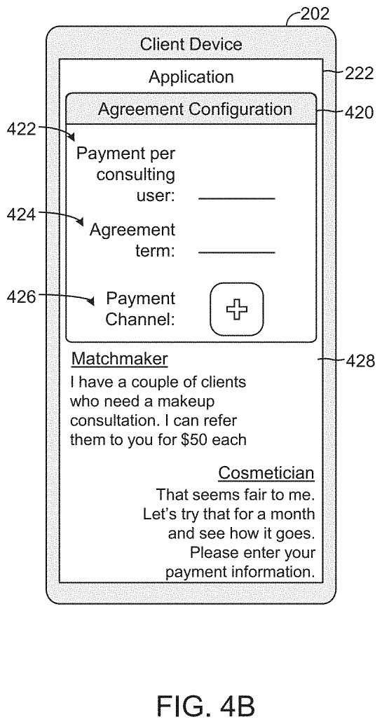

For example, as shown in FIG. 4A, when match seeker User A, operating client device 202a, sends a role-based relationship request to cosmetician User B, operating client device 202b, a chat interface 400 is displayed to the users by which the users can communicate and discuss services to be provided, terms of the role-based relationship, etc. User B is provided icons 402, 404 by which the role-based relationship request can be approved or denied. User A is provided with an icon 406 by which the role-based relationship request can be withdrawn and an icon 408 selectable to view the profile of User B (e.g., the profile 320 shown in FIG. 3C). These operations may be carried out using a relationship engine 410 and a chat engine 412 of the server 204. Other interactive elements and modes of communication are further within the scope of this disclosure. For example, User A and/or User B may initiate an audio call or a videochat, be presented with the ability to review details of the other user, and/or otherwise interact with one another and receive information relevant to the potential role-based relationship.

Many role-based relationships involve payments through a contractual agreement. For example, stylist or cosmetician consultations may charge for their services, and the amounts and types of those services can be configurable. In a matchmaker-match seeker relationship, payment might be contingent on successful matches, dates, or other outcomes. In a role-based relationship between a service provider and a merchandiser such as an apparel store or makeup store, the service provider may be entitled to a percentage of proceeds from clients of the service provider who buy goods from the merchandiser during consultations with the service provider.

Users may therefore be provided with user interfaces that permit discussion of agreements, in-application payment, agreement configuration, and other agreement-related interactions. For example, FIG. 4B shows an example of a user interface 420 that may be presented to a cosmetician user when finalizing a role-based relationship with a matchmaker user. This example role-based relationship allows the matchmaker to be compensated for referring match seeker clients to the cosmetician for consultations, e.g., by sending the clients an interactive option to request the consultations. The user interface 420 includes configurable settings for a per-consultation fee 422 to be paid to the matchmaker, a time range 424 over which the agreement will apply, and an option 426 to add a payment channel such as a bank account or third-party payment processor that will process payments associated with the agreement. A chat window 428 allows the cosmetician and matchmaker to negotiate these and other role-based relationship terms.

In some implementations, most or all aspects of a role-based relationship may be contained within the social network, such that the terms of the role-based relationship can be enforced by the social network. For example, if a matchmaker and a match seeker agree that payment is to be contingent on approval of matches by proposed romantic partners, the matches can be approved or denied within the social network, e.g., by a swipe-based interface, of a social network application corresponding to the social network, in which the match seeker is presented to the proposed romantic partners. When a match is approved, the social network can automatically process a corresponding payment in concordance with the agreed-upon terms of the role-based relationship. For example, the payment may be processed by the server 204. As another example, in a professional social network application, a role-based relationship may be established between an “employer”-role user and a “recruiter”-role user, in which the employer agrees to compensate the recruiter for each recruited “networker”-type user that interviews with the employer after a referral by the recruiter. Both the referrals and the interviews can be performed within the professional social network application, which then interacts with the server 204 to automatically transfer referral fees from the employer to the recruiter upon performance of the interviews.

Automatic execution of agreement terms in the context of role-based relationships can be implemented through smart contracts that monitor activities occurring within the scope of the role-based relationship and automatically execute operations such as payment transfer when agreed-upon conditions for those operations are met. In some implementations, the smart contracts are smart contracts written into blocks of a blockchain. Each user within the social network may correspond to a user on the blockchain, and the role-based relationships may be stored as blockchain transactions and/or smart contracts on the blockchain. In some implementations, at least some instances of the social network application installed on client devices are configured to act as blockchain nodes (e.g., lightweight blockchain nodes) to facilitate smart contract-based enforcement of terms of role-based relationships.

Many different roles may be implemented in various examples of the technologies described in this disclosure, only some exemplary roles being described explicitly herein. Each set (e.g., pair) of different roles or same roles corresponds to one or more role-based relationships that can be established between users having the set of roles, and each role-based relationship is associated with one or more types of role-based interactions that may take place within the scope of the role-based relationship. Some non-limiting examples of these role-based relationships and interactions have been described above, and more non-limiting examples are set forth below.

Many role-based interactions include live role-based sessions. During these sessions, the social network provides client devices associated with the two or more users in the relationship with synchronized, real-time-updating interfaces that can be cooperatively interacted with by the users to jointly carry out operations within the scope of the relationship.

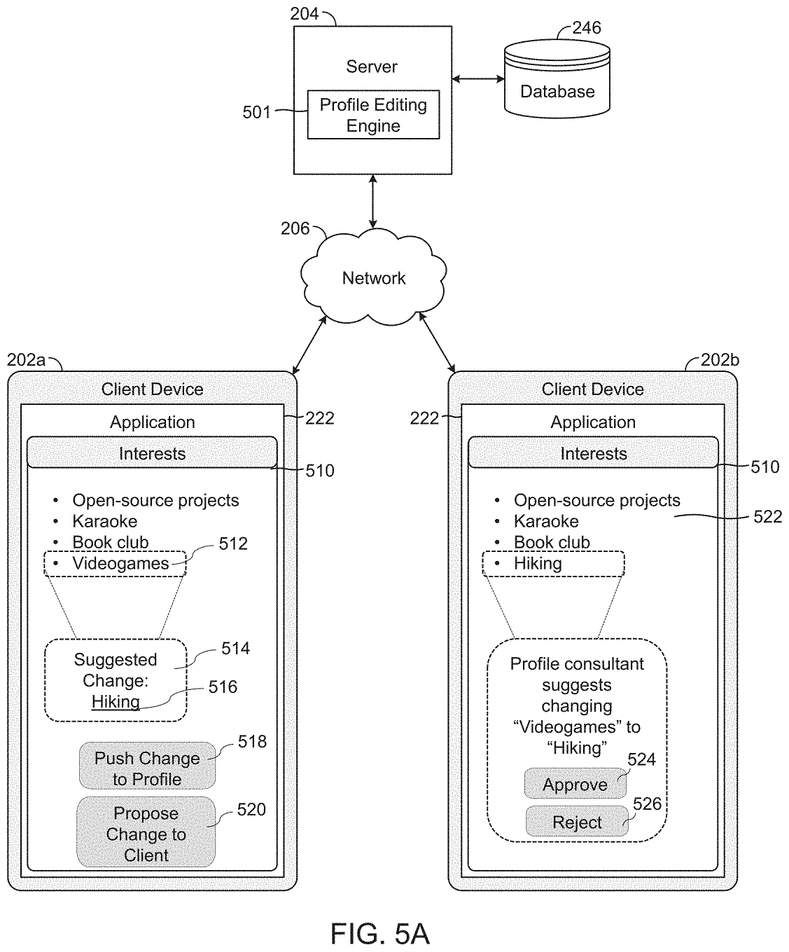

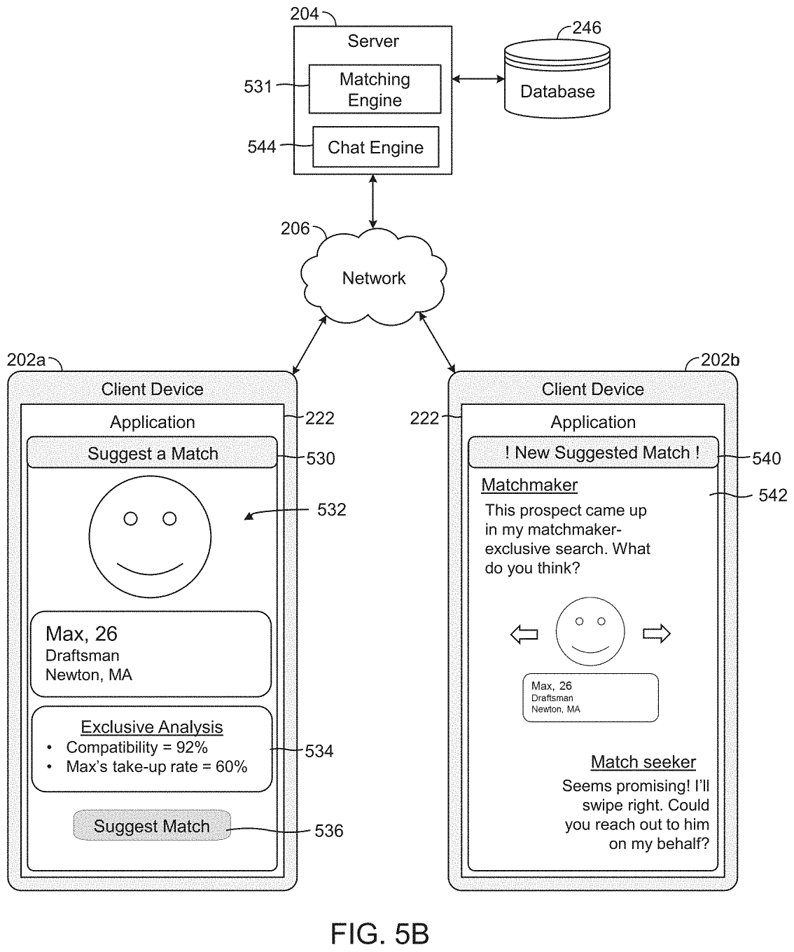

For example, as shown in FIG. 5A, a user with the role “profile consultant,” associated with client device 202a, is provided with a profile 510 of a match seeker associated with client device 202b. Because a role-based relationship has been established between the profile consultant and the match seeker, when the profile 510 is provided to the client device 202a, the profile 510 is provided by the server 204 (e.g., using a profile editing engine 501) with interface elements by which the profile consultant can propose and/or make changes to the profile 510. In this example, the profile consultant selects interest 512 and uses a pop-up entry box 514 to make a tracked change to an alternative interest 516. As another example, the profile consultant can suggest addition of a new field (e.g., astrological sign) to the profile 510. By selection of interface elements 518 or 520, the profile consultant can either propose the change to the match seeker for approval/disapproval, or simply push the change to the profile 510 without seeking confirmation from the match seeker. In real-time after the profile consultant makes the proposal, in the profile 510 shown on the client device 202b, the interest list 522 is shown with the proposed change already implemented, as a real-time preview to the match seeker. Interface elements 524, 526 allow the match seeker to approve or reject the proposed change.

FIG. 5B shows an example of synchronized matchmaking between a matchmaker and a match seeker. A matchmaker associated with client device 202a can view a “Suggest a Match” interface 530, which may be matchmaker-specific. The interface 530 shows a possible match 532 for the match seeker, e.g., a match revealed by a search that is available only to matchmaker users, a match suggested by a matching engine 531 of the server 204, and/or a match submitted by the match 532 themselves by swiping right on the match seeker. The interface 530 also includes analysis information 534 that is available only to matchmaker users. Searches and analyses that are provided only in the contexts of particular role-based relationships or particular roles are described in further detail below. The matchmaker can use the provided information to determine whether to suggest the match to a client. For example, the matchmaker can view astrological information of the match seeker and the suggested match and can suggest the match if matchmaker determines the astrological information to be compatible.

When the matchmaker selects a “Suggest Match” icon 536, the match seeker, in real time, receives a notification 540 of the suggested match and may participate in a real-time synchronized interaction with the matchmaker, including discussion of the suggested match. The suggested match can be integrated into an interface 640 on the client device 202b in a familiar fashion, such as being swipeable to indicate approval or disapproval of the match, which may be in keeping with a standard match seeking interface presented to the match seeker outside of the matchmaker-match seeker relationship.

Other aspects of matchmaker-match seeker relationships are also within the scope of this disclosure. For example, in some implementations, when a first user wishes to match with a second user who has a matchmaker-match seeker relationship with a matchmaker, the request from the first user is first routed to the matchmaker for review and approval or disapproval. If the matchmaker approves the request, a chat or other interaction is established between the first user and the second user. Similarly, automated suggested matches for the second user (e.g., suggested matches generated by the social network itself) can be first routed to the matchmaker for approval or disapproval.

Some role-based relationships can involve a review of a user's images. For example, a stylist may review a user's photos to get a sense of the user's general outfit choices and favored fashions. A cosmetologist may review a user's photos to find opportunities for improvements in the user's makeup selections. A matchmaker may review a user's photos to find photos that are particularly flattering or that highlight desirable aspects of the user's personality. Other roles and role-based relationships can involve further image interaction. Selected photos may also be edited in the context of real-time synchronized or asynchronous interactions.

Computer vision and/or machine learning methods may be applied to identify images that are relevant to different rules-based relationships. The user's images can be analyzed (either in advance of a request to obtain images matching a particular criterion, or when the request is received) in an image classification process to identify characteristics of the images. Non-limiting examples of such criteria are: images in which the user is alone or with friends; images in which the user's face is emphasized (e.g., facial portraits of the user); images in which the user's outfit is emphasized (e.g., full-body portraits of the user); images in which the user is dressed in a particular manner, e.g., wearing a suit; or images in which the user is participating in one or more predetermined activities such as giving a lecture or playing a sport.

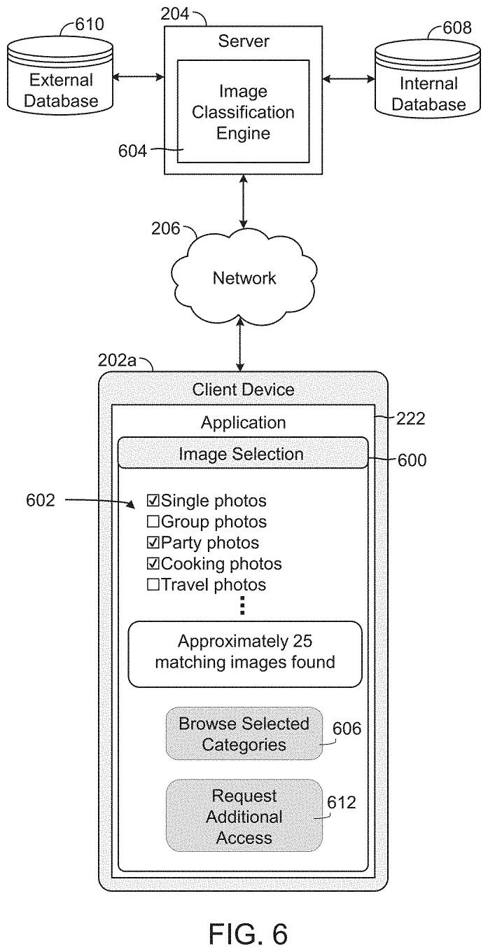

For example, as shown in FIG. 6, a matchmaker operating client device 202a is provided with an image selection interface 600 by which the matchmaker may request to browse particular categories 602 of images. The server 204 associated with the social network uses an image classification engine 604 to identify matching images, which are then provided to the client device 202a over the network 206 when the matchmaker selects interface element 606. Performing image classification and searching at the server 204 can significantly reduce network transmission loads compared to alternative systems in which a user's entire library of images (which may include thousands of images), or more images than are within the scope of a role-based relationship, are provided to the client device 202a for local image classification/searching and/or manual searching. In some cases, the reduction in network transmission load resulting from image classification-based pre-selection of images can be greater than 10×, greater than 100×, or more.

The searched images can be obtained from a variety of sources. Some images may be obtained from an internal database 608 associated with the social network in which the role-based relationship is established. Other images may be obtained from external databases 610 such as separate social networks or applications. In some implementations, users can be prompted to provide access to the separate social networks, e.g., when another user in a role-based relationship with the user selects element 612. The access-providing user can enter login credentials for the other social network, and images can be obtained by the server 204 using an application programming interface (API) or other access interface.

In some implementations, classification-based image provision is used as a basis to restrict image viewing for reasons of data privacy. For example, when a cosmetologist-match seeker relationship is established, the cosmetologist may be provided with facial portraits of the match seeker without being provided the ability to browse the match seeker's entire image library unrestricted and/or without being provided the ability to perform other image classification-based searches of the match seeker's image library. A recruiter may be prevented from viewing images that show a networker user in social settings such as bars. However, in some implementations, users may change configuration settings to remove these limitations and/or to provide access to additional images on an as-desired basis.

The images provided as a result of classification-based image provision can be utilized in a variety of ways within the scopes of different types of role-based relationships. For example, service providers may suggest that a profile be altered to include a provided image. In some implementations, certain service providers may send one or more provided images to a potential match (in the case of a matchmaker-match seeker relationship) or to a potential employer (in the case of a recruiter-networker relationship).

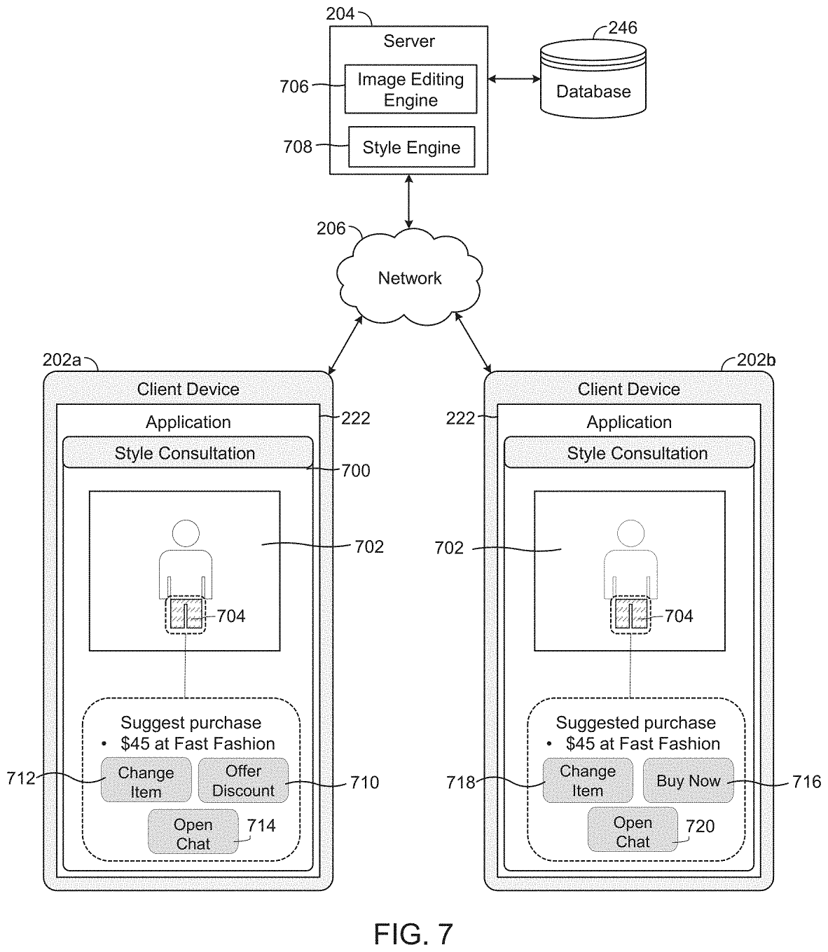

In some implementations, provided images are integrated into real-time synchronized role-based interactions. For example, FIG. 7 shows an example real-time synchronized role-based interaction between a stylist associated with client device 202a and a match seeker associated with client device 202b using a style engine 708. The stylist is provided with an interface 700 including an image 702 that has been classified as an outfit image, e.g., an image that shows most or all of the match seeker's outfit. The stylist is also provided with tools that allow the stylist to browse various apparel sources, such as online clothing stores. For example, websites or inventories of the online clothing stores may be openable from within an interface of the social network, such that the stylist can browse clothing options without leaving the social network.

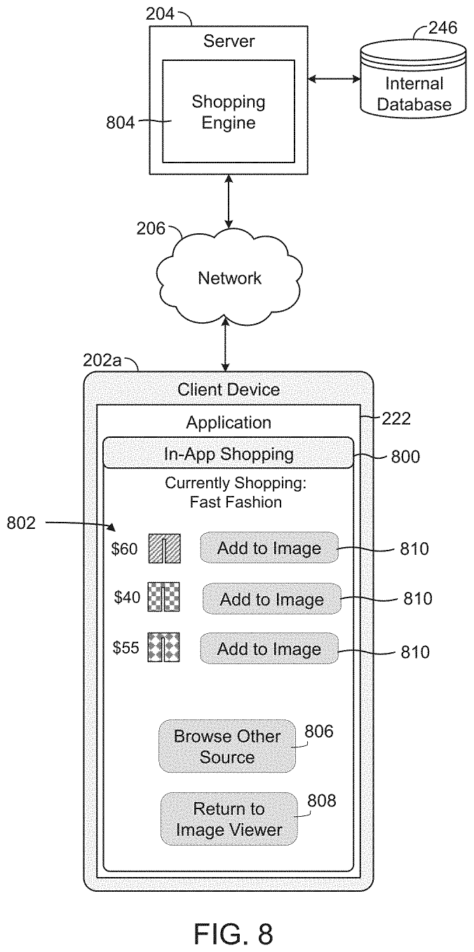

An in-application shopping interface 800 is shown in FIG. 8. A user may browse the offered clothing items 802 of an online store within the application 222 of the social network using a shopping engine 804 of the social network. In some implementations, the online store is associated with the social network itself, e.g., operates on the server 204 of the social network. In some implementations, the online store is a third-party store. When the online store is a third-party store, the integration of the third-party store into the application 222 can provide a more cohesive and well-controlled user experience than alternative methods such as opening a separate application for the third-party online store or browsing the third-party online store's offerings in a general web browser application. Moreover, in some implementations, because the social network directly manages interfacing between the user and the third-party business, the social network may limit an amount of data transmitted to the client device 202a, e.g., may transfer no ads or fewer advertisements than would be transferred if the third-party online store were accessed through its own application or through a general web browser application. This can enhance the user experience and also improve network transmission efficiency by decreasing an amount of transferred data. Interface controls 806, 808, 810 in the in-application shopping interface 800 allow the user to select a clothing item 802 to be automatically added to the image 702, to select another source to browse (e.g., another clothing supplier), or to return to the interface 700.

Referring back to FIG. 7, when the stylist selects a clothing item 704 using the in-application shopping interface 800, the image 702 is automatically digitally altered to portray the match seeker wearing the clothing item 704. The alteration may be performed such that the image 702 is kept substantially unchanged otherwise. In some implementations, the alteration is performed at the server 204 by an image editing engine 706, and/or the alteration may be performed locally on the client device 202a. The stylist is also presented with other options, e.g., interface elements 710, 712, 714 that allow the stylist to change the selected clothing item (e.g., by opening the in-application shopping interface 800), to offer a discount on the clothing item 704, or to open a chat with the match seeker. In some implementations, discount options are dependent on other role-based relationships. For example, the stylist may have a role-based relationship with a second, business-associated stylist that allows the stylist to offer discounts on the second stylists' clothing offerings.

As part of the stylist-match seeker relationship, the altered image 702 is provided (e.g., in real time) to the client device 202b for viewing by the match seeker. Using interface elements 716, 718, 720, the match seeker may buy the suggested clothing item 704, select an alternative clothing item (e.g., using in-application browsing as described above), or open a chat with the stylist.

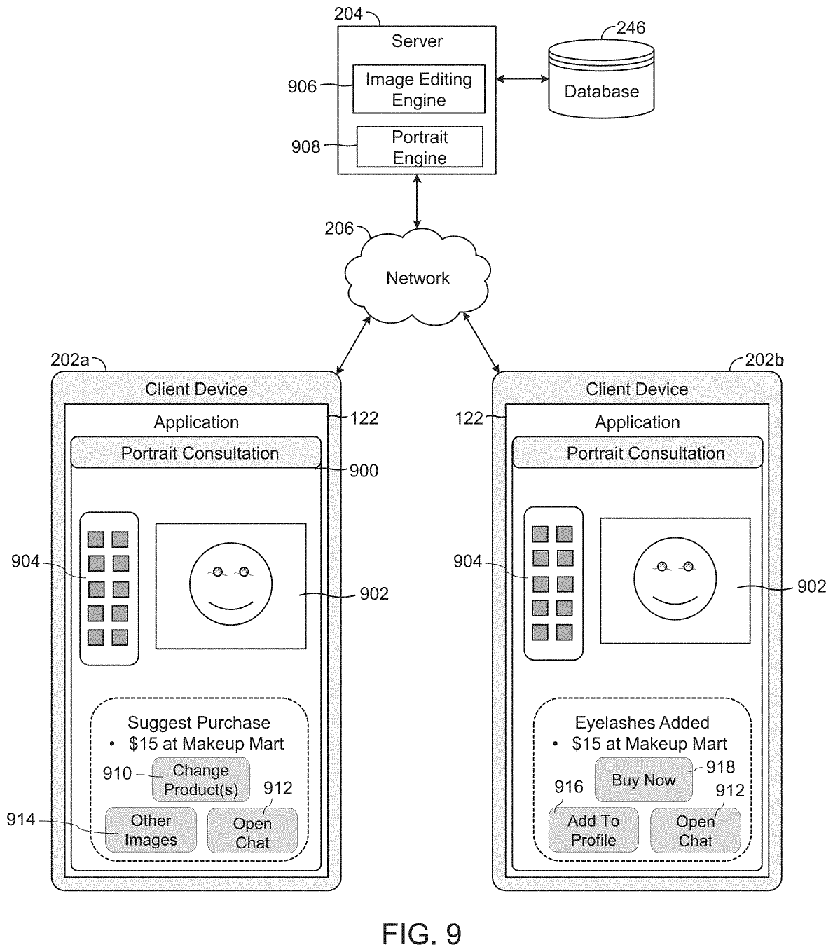

As shown in FIG. 9, a similar real-time role-based interaction may be provided in the context of portrait consultations. For example, a cosmetician-match seeker relationship may include a portrait consultation to discuss makeup application tips and potential product purchases. As another example, a profile consultant-match seeker or profile consultant-networker relationship may include a portrait consultation to select a primary profile image and edit the image. The service provider interacts with an interface 900 to edit a facial portrait 902 selected by an image classification process at the server 204, as described above. Editing the facial portrait 902 may include using image editing tools 904 such as smoothing filters and brushes, feature distortion tools (e.g., eye wideners), and brush effects to simulate the application of various colors of blush, lip gloss, and other cosmetic items. The facial portrait 902 may also be edited to simulate the use of specific products. In this example, the facial portrait 902 has been edited to include false eyelashes available for purchase from Makeup Mart. The products may be selected using an in-application browsing interface, as described in reference to FIG. 8. Changes made by one user are synchronized with the other user's display in real time. Processing associated with the image editing may be performed by an image editing engine 906 of the server 204, and processing associated with at least some other operations of the portrait consultation may be performed by a portrait engine 908 of the server 204.

Interface control 910 allows the service provider to select alternative products to be added to the facial portrait 902. Interface controls 912 allow the users to open a chat interface. Interface control 914 allows the service provider to select an alternative image to be viewed and/or edited from a list of facial portrait images pre-selected by an image classification process performed at the server 204. Interface control 916 allows the service receiver (e.g., the match seeker or networker) to publish the edited image to their profile, and interface control 918 allows the service receiver to be taken to a purchasing interface to buy the specific product that the facial portrait 902 was edited to include.

As is the case for all example interfaces and interactions described in this disclosure, other interface controls and associated operations besides those explicitly disclosed may be included in various implementations within the scope of this disclosure.

In some implementations, interactions described above in the context of real-time synchronized interactions may instead or additionally be implemented not in real-time. For example, already-proposed profile changes may be presented to a match seeker when the match seeker opens their social network application. A cosmetician may edit a user's profile picture without the user being logged in or active at the same time. In a match seeker-match seeker role-based relationship, users may “swipe” each other asynchronously.

Users may have multiple roles that define their possible role-based relationships, and may be in multiple role-based relationship with the same user simultaneously. For example, a recruiter and a networker may have both a “friend”-type role-based relationship and a “job prospect”-type role-based relationship that is established on an as-needed basis when the recruiter wishes to recruit the networker for a particular job. The networker may also be a match seeker able to establish match seeker-match seeker relationships as well as match seeker-service provider relationships (e.g., role-based relationships with cosmeticians and profile consultants). Managing the large number of possible permutations and combinations of roles and role-based relationships may introduce significant complexity into the social network. Therefore, in some implementations, technical aspects of the social network are structured for compatibility with the roles and role-based relationships of the social network.

Some implementations include automated role-based matching between users of different roles based on matching criteria. In automated role-based matching, role-based relationships that can be established are suggested, such as recommending a stylist to a match seeker or recommending a sponsorship relationship between a stylist and an apparel supplier. One or more of the users in the proposed relationship may receive a message or notification allowing them to agree to the relationship, send a match request to another user in the proposed relationship, or otherwise confirm or deny the proposed relationship.

The automated matching may be performed using one or more machine learning models (e.g., of an automated role-based matching engine of the server 204) in a similar manner to romantic relationship matching, with model inputs including past activities of the users, reviews of the users, profile data of the users, existing role-based relationships of the users and users in their social networks, selections by users (e.g., preferred age ranges or service types) and/or other data. For example, a stylist may be recommended to a match seeker based in part on the stylist having previously established role-based relationships with the match seeker's friends. Roles and role-based relationships may be integrated into the training of the machine learning models and operations of the machine learning models. For example, at least some data used to train the models can be labeled with roles of users and role-based relationships that the users participate in. The machine learning models may operate subject to role-related constraints, e.g., recommended relationships between users must be constrained to those role-based relationship types defined by their respective roles.

By incorporating roles into this automated matching process, matching may be performed more efficiently, because the roles constitute an additional parameter upon which matching can be based, and the possible role-based relationships impose constraints such that less useful or less desired pairings can be reduced. This may reduce overall processing and network resources necessary for matching and social network operation, because suggested relationships will, on average, be more likely to succeed, such that fewer matching cycles (with corresponding consumption of processing resources) are necessary. In addition, because automated matching can use roles as a constraint, the search space for role-based matching may be smaller than for non-role-based matching, reducing the processing resources used for each matching operation.

Moreover, because users are able to access services through role-based relationships within the social network environment, their other relationships may progress more successfully/efficiently. For example, a match seeker who has formed a role-based relationship with a stylist may have an improved profile due to the stylist's advice and other services. The match seeker may then be more efficiently matched with other match seekers (for example, other match seekers may be more likely to “swipe right” on the match seeker), and the resulting relationships are then more likely to progress quickly to an offline stage, e.g., offline dating. This reduces processing resource consumption and network resource consumption that would otherwise be needed for the match seeker to continue using online aspects of the social network.

For at least these reasons, role-based matching and role-based relationships represent an improvement to the technology of social network relationship recommendation.

In some implementations, at least some stored data elements (“elements”) of the social network are each be associated with one or more role-based relationships and/or with one or more roles. The elements may include user interface elements such as selectable icons, application features, operations and functions performable by client devices or requestable by client devices to be performed at a remote server, user images, user statistics, protected user data (e.g., user data with restricted view access, such as private information), and/or other data elements. The elements may also include elements representative of users themselves, to store each user's roles and established role-based relationships. Each element may be stored in a database in association with labels for one or more types of role-based relationships and/or roles, and/or each element may include (as data sub-elements of the element) the labels for the types of one or more role-based relationships and/or roles. For example, at least some elements may include a “role” field and/or a “role-based relationship” field (e.g., in a header or metadata of the elements) by which the roles and/or role-based relationships associated with the elements can be identified. In some implementations, the elements may be associated with object classes that mediate the association between types of role-based relationships and/or roles and elements, e.g., in a multiple inheritance arrangement. A variety of organizational frameworks for the association of elements with types of role-based relationships and/or roles are within the scope of this disclosure.

Using these and other data-organizational frameworks in which different roles are built into underlying data elements and relationships between data elements, social network processing efficiency and network resource efficiency can be improved. Interactions between users can be specifically tailored to those interactions that suit their respective roles, such that unnecessary data (e.g., photos that are not relevant to their role-based relationship, application operations beyond the scope of their role-based relationship, and user interface elements that correspond to data and operations beyond the scope of their role-based relationship) are not transmitted to client devices and/or are not subject to unnecessary resource-consuming processing. For example, elements beyond the scope of the role-based relationship may be filtered out preliminarily in a search operation that is allowed in the role-based relationship. Therefore, the technologies of social network data organization and social network data provision can be improved.

When a client device associated with a first user requests elements associated with a second user and/or elements relevant to operations within the scope of one or more role-based relationships between the first user and the second user, servers of the social network (e.g., server 204) identify, from a pool of elements, a subset of elements that are associated with the one or more role-based relationships established between the first user and the second user.

In some implementations, the subset of elements includes images of the second user. For example, the images may have undergone image classification and, as a result, been each associated with one or more role-based relationships and/or roles. The association may be based on recognized elements of the images, recognized settings of the images, time and/or location of capture of the images, and/or other factors. Images may instead or additionally be associated with role-based relationships by other processes. For example, a user may manually label images to be associated or not associated with particular role-based relationships.

In some implementations, the subset of elements includes user interface elements corresponding to operations that fall within the scope of role-based relationships and/or roles. User interface elements to initiate various chats, real-time synchronized interactions, and other interactions are associated with role-based relationships and/or roles and are provided to users when those role-based relationships have been established and/or when the user is associated with the roles. For example, within a portrait consultation as shown in FIG. 9, the image editing tools 904 may be provided only in the context of a first type of role-based relationship, the user interface element 914 to browse additional images of the other user (and the additional images themselves) may be provided only in the context of a second type of role-based relationship, and both elements 904, 914 may be provided if both the first and second types of role-based relationship have been established between the two users.

In operation, as shown in FIG. 10, when a client device 202a, associated with a user, transmits a request 1000 to the server 204, a role-based element selection engine 1002 queries a database 246 to select a subset of elements associated with the relevant role-based relationships and roles. For example, the element selection engine 1002 identifies elements that are associated with one or more roles of the user, and the element selection engine 1002 also identifies elements that are associated with one or more role-based relationships established between the user and another user. In some implementations, this querying and selection is performed based on one or more discrete rules, e.g., “IF (role_relationship_1 EXISTS) THEN (PROVIDE fashion_images).” Querying and selection may instead or additionally be based on a machine learning approach in which elements are selected in a flexible, dynamic manner. For example, one or more machine learning models may be used to associate each element with a score. Inputs to the machine learning models can include, for example, the roles of the users, types of role-based relationship(s) between the users (if any), data of past interactions between the users, user profile data of the users, or a combination thereof, and/or other data. A subset of the elements is then selected based on the scores. For example, a number of elements having higher scores than other elements can be selected.

When elements have been selected, in some implementations a layout engine 1004 combines at least some of the selected user interface elements into a user interface 1006 to be transmitted to the client device 202a. In some implementations, selected elements 1008 besides the user interface 1006 are also transmitted and may be stored locally on the client device 202a until called in the social network application of the client device 202a. For example, otherwise-private statistics or images of a user, available because of an agreed-upon role-based relationship, may be transmitted to the client device 202a and stored in a cache of the client device 202a until needed.

In some implementations, some selected elements that are associated with the relevant role-based relationship are not immediately transmitted to the client device 202a but rather are recorded at the server 204 to be called later. For example, these elements may be prepared in a cache or other storage 1012 coupled to the server 204 for quick retrieval at a later point in time. In some implementations, a storage structure of the storage 1012, server 204, or database 246 is updated to facilitate quick retrieval of the elements. For example, a database index or table index may be updated to reflect the relevant role-based relationships and roles, such that elements within the scope of the role-based relationships and roles can be retrieved more quickly in the future.

The layout engine 1004 may use hard-coded layout rules, machine learning algorithms, or a combination thereof to present the selected user interface elements in a manner that preserves user experience. For example, an order and location of a first user interface element may be kept consistent even while one or more other user interface elements are either present or not present in the user interface 1006. Performing the element selection and/or user interface generation processes at the server 204 may reduce total network transmission loads, because only the relevant elements are transmitted to the client device 202a: network transmission resources are not wasted on assets that will not be utilized because they are outside the scope of roles or role-based relationships. In addition, because elements are effectively filtered at the server 204 before transmission to the client device 202a, the chances of data security violations (e.g., packet interception to obtain elements that are not within the scope of existing role-based relationships) may be reduced.

As noted throughout this disclosure, in some implementations, elements may be associated not only with particular role-based relationships but also, or instead, with particular roles. For example, in some implementations, users with certain roles may be provided with additional information about some other users, even in the absence of a particular role-based relationship with the other users. The “take-up rate” of FIG. 5B is an example of such information. The take-up rate may be associated with the matchmaker role to aid matchmakers in recommending matches, e.g., to help matchmakers determine which users are more likely to be responsive to proposed matches. However, to improve user privacy, the take-up rate of users is not provided to non-matchmaker users. In some implementations, an application and vetting process may be implemented before users are provided with certain role-based information and/or before users are allowed to take on certain roles, in order to reduce exploitation of this role-based data access.

In some implementations, a social network may include marketplace features that facilitate forming role-based relationships. The server can provide client devices with reviews of users with various roles, recommendations for users with whom to form role-based relationships, discounts and other benefits to encourage forming role-based relationships, and/or other information. The marketplace can also host payment functions to facilitate user-to-user payments that can be associated with certain role-based relationships.

In some implementations, the server 204 includes an agent engine that functions as an automated user performing the operations of one or more roles. For example, the agent engine may function as an automated recruiter and profile consultant user that, with users' assent, can provide the users with suggested job openings and proposed improvements to the users' professional profiles, as would be done by a human recruiter user and/or profile consultant user. Payment for services performed by automated users can be provided to the social network itself.

Although much of this disclosure has described interactions between two users in a two-user role-based relationship, aspects of role-based social networks can encompass relationships between single users and groups of users, and/or between groups of users and other groups of users. For example, rather than consulting with one stylist, a match seeker may form a group role-based relationship with a group of stylists, such as a group of stylists associated with a business. Each stylist may interact with the match seeker singly, and/or joint simultaneous interactions between the user and multiple stylists of the group of stylists can be facilitated by the social network through appropriate interfaces of the application.

In some implementations, the social network imposes restrictions on role-based relationships. For example, each match seeker may be restricted to a single matchmaker-match seeker relationship at any one time.

In some implementations, the social network provides an API 1020 with which third party entities can interact to integrate into role-related aspects of the social network. The API 1020 may be integrated into the server 204 or deployed external to the server 204. For example, third party entities can become business users on the social network, such as user 102d of FIG. 1. Third party entities may interact with the API 1020 to become browsable in an in-application shopping interface.

Automated users need not be operated by the social network itself. Rather, in some implementations, third party entities may interact with the API 1020 to set up their own automated users having one or more roles. These automated users can enter into at least some role-based relationships as described throughout this disclosure, e.g., as service providers. Rule-based engines, machine learning-based engines, or both rules-based and machine learning-based engines can interact with the server 204 through the API 1020, and/or the engines can be provided through the API 1020 for deployment, e.g., deployment on the server 204. The engines behave as automated users on behalf of the third-party entities providing the engines. For example, an apparel business may provide an automated stylist user configured to enter into match seeker-stylist relationships and suggest purchases from the apparel business.

Automated users may be conspicuously marked, e.g., on their profiles, so that users entering into role-based relationships with the automated users are aware of their automated nature.

Some implementations of the social network include a substitutional matching system. The substitutional matching system may be used in conjunction with a role-based system as described throughout this disclosure, or may be used in other social network implementations that do not include a role-based system.

In a substitutional matching system, at least some users who are subjects of a matching process can, after being matched with a second user (e.g., after agreeing to a match with the second user and/or after being proposed a match with the second user), substitute a third user for themselves, allowing the third user to interact with the second user as if the third user had been initially matched with the second user. The third user has an existing relationship with the first user, e.g., is a friend of the first user in the social network or another social network. For example, a first user may recognize that their friend would make a better romantic match to a second user than would the first user, even though the first user has been matched with the second user by a matchmaker or by an automated matching engine. In such a situation, the first user may be provided with an interface by which the first user can send substitution request messages to the friend and/or to the second user, to receive approval from the friend and/or the second user to make a match substitution. Upon successful approval, the social network makes a substitutional match between the friend and the second user, e.g., opens communication between the friend and the second user and/or allows a greater degree of profile visibility between the friend and the second user.

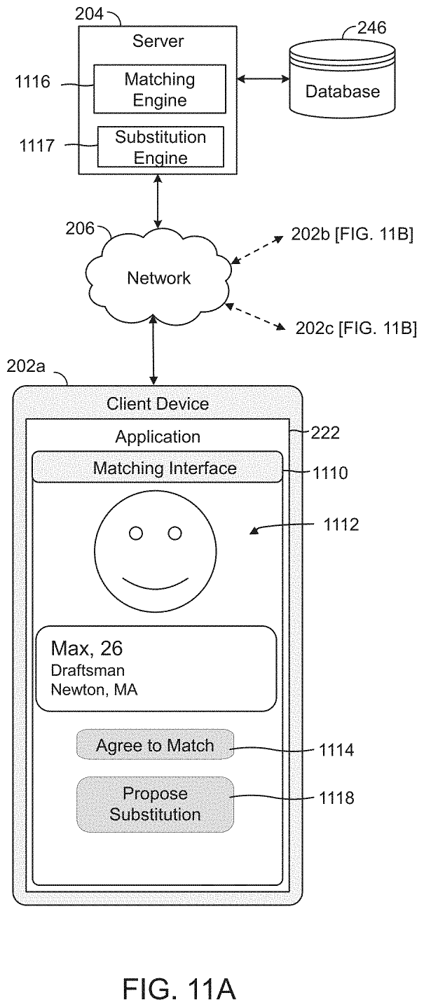

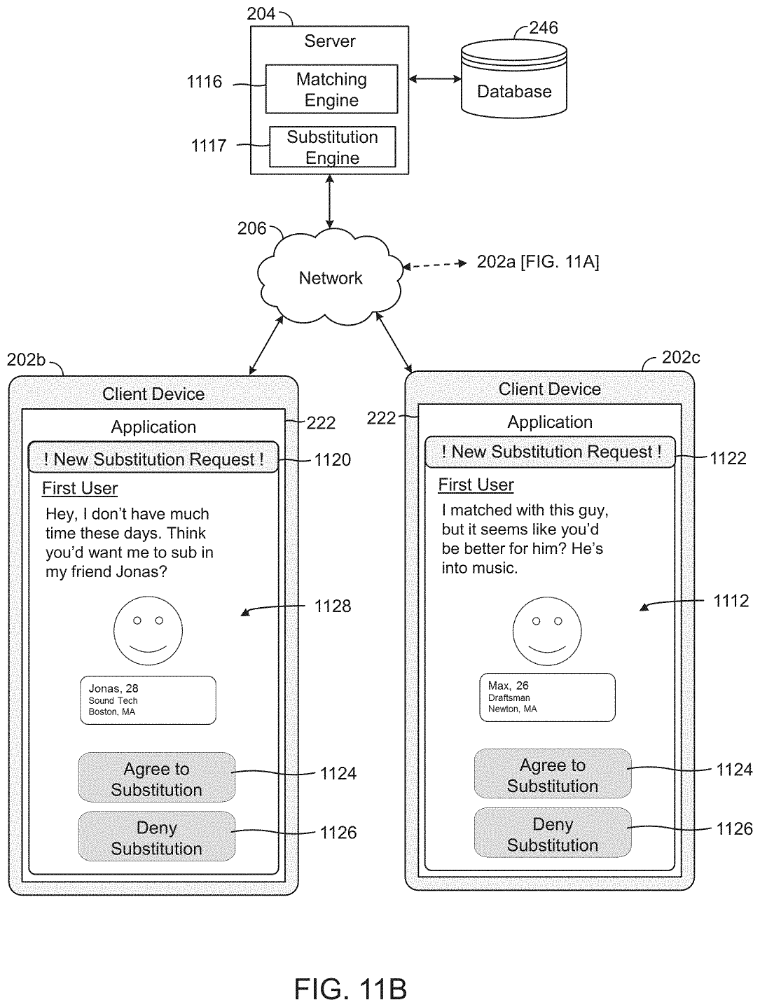

For example, as shown in FIG. 11A, a first user associated with a first client device 202a is provided with a matching interface with respect to a second user 1112. The matching interface may be an initial matching interface 1110 presented to the first user as shown in FIG. 11A, e.g., an initial matching interface 1110 by which the first user may approve or deny a match with the second user 1112 using an interface element 1114. For example, the initial matching interface 1110 may be provided after a matchmaker (with whom the first user has established a matchmaker-match seeker role-based relationship) recommends the second user 1112 to the first user, or the initial matching interface 1110 may be provided after an automated matching engine 1116 recommends the second user 1112 to the first user based on profile information of the users. In some implementation, the matching interface is an approved match interface (not shown) that is presented to the first user after the first user has agreed to a match with the second user. For example, an approved match interface may enable network communications (e.g., video and/or text chat), provide expanded profile viewing operations, and provide other elements reflective of an agreed-upon match. In some implementations, these elements are associated with an established match seeker-match seeker role-based relationship between the first user and the second user 1112.

The matching interface (e.g., initial matching interface 1110) includes a substitution element 1118 by which the first user may initiate a substitution proposal process performed using a substitution engine 1117. As shown in FIG. 11B, the substitution proposal process may include substitution requests 1120, 1122 sent to either or both of the second user 1112 (associated with client device 202b) and a third user 1128 associated with client device 202c. In some implementations, the third user 1128 has an existing relationship with the first user in the social network, e.g., is a friend of the first user or has a role-based relationship with the first user.

Using interface elements 1124, 1126, the second user 1112 and the third user 1128 may confirm or deny the proposed substitution. In some implementations, both the second and third users 1112, 1128 must agree to the substitution in order to establish the substitution. In some implementations, only the second user 1112 or only the third user 1128 is asked to confirm or deny the substitution.

In some implementations, if the substitution is denied, the match or proposed match between the first user and the second user 1112 is also canceled. For example, the first user and the second user 1112 may be automatically unmatched, or a proposed match between the first user and the second user 1112 may be revoked, e.g., by removing the second user 1112 from a list of possible matches to be browsed by the first user, or by preventing network communication between the first user and the second user 1112.

If the substitution is approved, then a match or a proposed match is established between the second user 1112 and the third user 1128. In some implementations, the substitutional match is initiated at a stage that matches a latest stage of the match between the first user and the second user 1112 when the substitutional match was proposed. For example, if the substitution process occurs at an initial matching stage (e.g., when the first user has been presented with a swipable profile of the second user 1112 but has not yet approved the match with a right swipe), then the match between the second user 1112 and the third user 1128 may be initiated at that same initial matching stage, e.g., the third user 1128 may be presented with a swipable profile of the second user 1112. As another example, if the first user and the second user 1112 have already agreed to a match between one another, then, when the substitutional match is approved, the second user 1112 and the third user 1128 may be placed at that same matched relationship stage and be provided with corresponding social network elements, e.g., chatting and full profile viewing.

In some implementations, a substitutional match is initiated at a stage different from that of a stage of the match from which the substitution was proposed. Even if the first user and the second user 1112 have already agreed to a match between one another, the substitutional match between the second user 1112 and the third user 1128 may be initiated at an earlier (e.g., initial) matching stage. For example, the second user 1112 may be presented with a swipable profile of the third user 1128 that can be approved or disapproved, even though the second user 1112 has already approved the first user by swiping.

A substitutional match may, but need not, replace the match from which the substitution is proposed. In some implementations, if the substitution is approved, the initial match (e.g., the match between the first user and the second user 1112) is automatically canceled. In some implementations, the initial match is maintained even if the substitution is approved. In some implementations, the initial match is canceled whether or not the substitution is approved, e.g., even if the second user 1112 and/or the third user 1128 denies the substitution; the proposal of the substitution may be interpreted as an indication that the initial match is unsatisfactory.

In many cases, because the user proposing the substitution has an existing relationship with the substituting user, the substitutional match is expected to be relatively successful, e.g., because of known compatibilities between the users in the substitutional match. While some of these compatibilities may be known by the social network such that they are accounted for during automated or non-automated matchmaking, other compatibilities may be unknown to the social network but nevertheless relevant to a successful match, such as a recent break-up, a new hobby, or a niche shared interest. Because the substitutional match may be made on the basis of these characteristics, the match may be expected to be relatively successful, e.g., more successful than an average automated match. The substitutional match may therefore be more likely to progress quickly to an offline stage, e.g., offline dating. This reduces processing resource consumption and network resource consumption that would otherwise be needed for the users in the substitutional match to continue using online aspects of the social network.

In some implementations, a substitutional matching system is integrated together with a role-based system as described in this disclosure. For example, in some implementations, substitutions are restricted based on user roles. A first user may be allowed to propose substitutions only with users having a same role as the first user, e.g., a match seeker may propose to replace themselves with only another match seeker, or a stylist may propose to replace themselves with only another stylist. In the context of a role-based relationship, this arrangement maintains the type of role-based relationship of the initial match into the substitutional match. Regulation of substitution requests may be regulated in a role-based system as described for other role-based interactions in this disclosure, e.g., as described in reference to FIG. 10. For example, when a first user, having a first role in a role-based relationship, selects a “Request Substitution” interface element, a database of users is queried. Each user is associated with one or more roles, and only users having the first role are provided to the first user to be selected for a proposed substitution. In some implementations, when a substitution is proposed in a role-based relationship, the substituting user is provided with the terms of the role-based relationship for review before the substituting user approves the substitution.

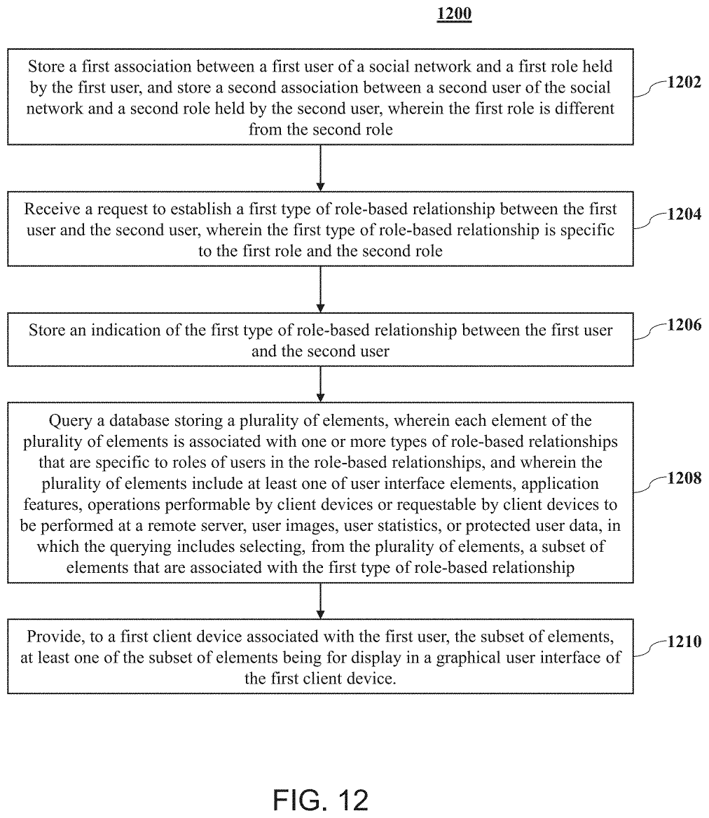

As shown in FIG. 12, some implementations include a process 1200. In the process 1200, a first association between a first user of a social network and a first role held by the first user is stored, and a second association between a second user of the social network and a second role held by the second user is stored (1202). The first role is different from the second role. A request is received to establish a first type of role-based relationship between the first user and the second user. The first type of role-based relationship is specific to the first role and the second role (1204). An indication of the first type of role-based relationship between the first user and the second user is stored (1206). A database storing a plurality of elements is queried (1208). Each element of the plurality of elements is associated with one or more types of role-based relationships that are specific to roles of users in the role-based relationships, and the plurality of elements includes at least one of user interface elements, application features, operations performable by client devices or requestable by client devices to be performed at a remote server, user images, user statistics, or protected user data. The querying includes selecting, from the plurality of elements, a subset of elements that are associated with the first type of role-based relationship. The subset of elements are provided to a first client device associated with the first user, at least one of the subset of elements being for display in a graphical user interface of the first client device (1210).

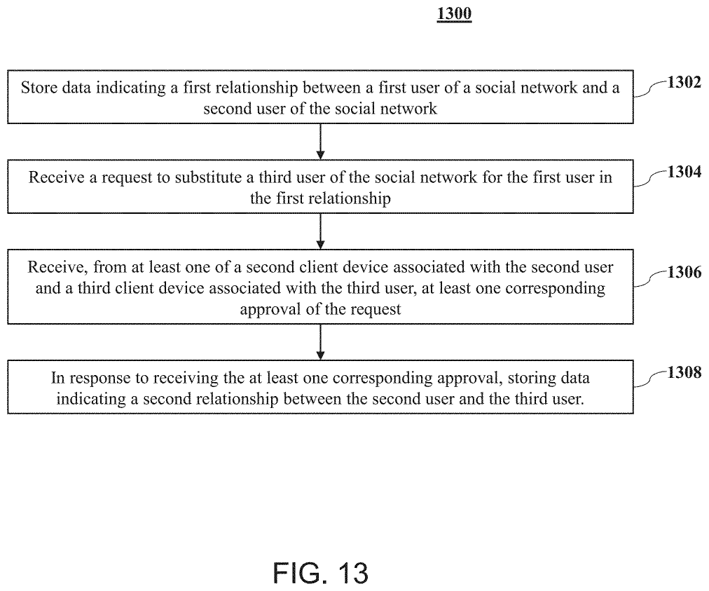

As shown in FIG. 13, some implementations include a process 1300. In the process 1300, data is stored indicating a first relationship between a first user of a social network and a second user of the social network (1302). A request is received to substitute a third user of the social network for the first user in the first relationship (1304). From at least one of a second client device associated with the second user and a third client device associated with the third user, at least one corresponding approval of the request is received (1306). In response to receiving the at least one corresponding approval, data is stored indicating a second relationship between the second user and the third user (1308).

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable processing system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” or “computer-readable medium” refer to any computer program product, apparatus and/or device (e.g., magnetic discs, optical disks, memory, Programmable Logic Devices (PLDs)) used to provide machine instructions and/or data to one or more programmable processors, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback). Input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by the data processing apparatus, cause the apparatus to perform the operations or actions.

Although a few implementations have been described in detail above, other modifications are possible. Logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

What is claimed is:

1. A computer-implemented method comprising:
storing a first association between a first user of a social network and a first role held by the first user, and storing a second association between a second user of the social network and a second role held by the second user, wherein the first role is different from the second role;
receiving a request to establish a first type of role-based relationship between the first user and the second user, wherein the first type of role-based relationship is specific to the first role and the second role;
storing an indication of the first type of role-based relationship between the first user and the second user;
querying a database storing a plurality of elements, wherein each element of the plurality of elements is associated with one or more types of role-based relationships that are specific to roles of users in the role-based relationships, and wherein the plurality of elements comprises at least one of user interface elements, application features, operations performable by client devices or requestable by client devices to be performed at a remote server, user images, user statistics, or protected user data, in which the querying includes selecting, from the plurality of elements, a subset of elements that are associated with the first type of role-based relationship; and
providing, to a first client device associated with the first user, the subset of elements, at least one of the subset of elements being for display in a graphical user interface of the first client device.

2. The computer-implemented method of claim 1, wherein the subset of elements comprises data associated with the second user, and wherein the first user is excluded from obtaining the data associated with the second user in the absence of the first type of role-based relationship.

3. The computer-implemented method of claim 1, comprising:
applying a trained image classification machine learning model to a set of images associated with the second user;
obtaining, as an output of the trained image classification machine learning model, image classification labels for images of the set of images; and
based on the image classification labels, storing an association between a first image of the set of images and the first type of role-based relationship,
wherein the subset of elements includes the first image.

4. The computer-implemented method of claim 3, wherein storing the association between the first image and the first type of role-based relationship is based on an object depicted in the first image.

5. The computer-implemented method of claim 1, wherein the subset of elements comprises a selectable user interface element.

6. The computer-implemented method of claim 5, comprising:
subsequent to selecting the subset of elements, generating a user interface including the selectable user interface element; and
providing the user interface to the first client device for display on the first client device.

7. The computer-implemented method of claim 1, comprising:
providing, to the first client device and to a second client device associated with the second user, a social network profile of the second user;
receiving, from the first client device, a proposed change to the social network profile, wherein the proposed change is indicated on the first client device using a first element of the subset of elements;
providing, to the second client device, the social network profile modified to incorporate the proposed change; and
receiving, from the second client device, an indication of approval or disapproval of the proposed change.

8. The computer-implemented method of claim 1,
determining that an image associated with the second user matches a predetermined criteria;
based on determining that the image associated with the second user matches the predetermined criteria, storing an association between the image and the first type of role-based relationship;
providing, to the first client device and to a second client device associated with the second user, the image, wherein the image is included in the subset of elements;
receiving, from the first client device, a proposed change to the image;
modifying the image to incorporate the proposed change, to obtain a modified image; and
providing the modified image to the first client device and the second client device.

9. The computer-implemented method of claim 8, comprising:
adding the modified image to a profile page of the second user.

10. The computer-implemented method of claim 8, wherein modifying the image comprises modifying the image to incorporate a product proposed by the first user.

11. The computer-implemented method of claim 1, comprising:
storing a third association between the first user of the social network and a third role held by the first user, wherein the first user holds the first role and the third role simultaneously;
receiving a request to establish a second type of role-based relationship between the first user and the second user, wherein the second type of role-based relationship is specific to the third role and the second role;
storing an indication of the second type of role-based relationship between the first user and the second user, wherein the second type of role-based relationship exists simultaneously with the first type of role-based relationship;
selecting, from the plurality of elements, a second subset of elements that are associated with the second type of role-based relationship; and
providing, to the first client device, the second subset of elements.

12. The computer-implemented method of claim 1, comprising:
prior to receiving the request, providing, as inputs to a machine learning model, data of the first user, data of the second user, the first role, and the second role;
obtaining, as an output of the machine learning model, a recommendation to establish the first type of role-based relationship between the first user and the second user; and
sending, to at least one of the first user and the second user, the recommendation to establish the first type of role-based relationship between the first user and the second user.

13. The computer-implemented method of claim 1,
wherein providing the subset of elements to the first client device comprises initiating a live communication session between the first client device and a second client device associated with the second user.

14. The computer-implemented method of claim 13, wherein the live communication session comprises live video communication.

15. One or more tangible, non-transitory, computer-readable media storing instructions that, when executed by a processing system, cause the processing system to perform operations comprising:
storing a first association between a first user of a social network and a first role held by the first user, and storing a second association between a second user of the social network and a second role held by the second user, wherein the first role is different from the second role;
receiving a request to establish a first type of role-based relationship between the first user and the second user, wherein the first type of role-based relationship is specific to the first role and the second role;
storing an indication of the first type of role-based relationship between the first user and the second user;
querying a database storing a plurality of elements, wherein each element of the plurality of elements is associated with one or more types of role-based relationships that are specific to roles of users in the role-based relationships, and wherein the plurality of elements comprises at least one of user interface elements, application features, operations performable by client devices or requestable by client devices to be performed at a remote server, user images, user statistics, or protected user data, in which the querying includes selecting, from the plurality of elements, a subset of elements that are associated with the first type of role-based relationship; and
providing, to a first client device associated with the first user, the subset of elements, at least one of the subset of elements being for display in a graphical user interface of the first client device.

16. The computer-readable media of claim 15, wherein the subset of elements comprises data associated with the second user, and wherein the first user is excluded from obtaining the data associated with the second user in the absence of the first type of role-based relationship.

17. The computer-readable media of claim 15, wherein the operations comprise:
applying a trained image classification machine learning model to a set of images associated with the second user;
obtaining, as an output of the trained image classification machine learning model, image classification labels for images of the set of images; and
based on the image classification labels, storing an association between a first image of the set of images and the first type of role-based relationship,
wherein the subset of elements includes the first image.

18. The computer-readable media of claim 15, wherein the operations comprise:
storing a third association between the first user of the social network and a third role held by the first user, wherein the first user holds the first role and the third role simultaneously;
receiving a request to establish a second type of role-based relationship between the first user and the second user, wherein the second type of role-based relationship is specific to the third role and the second role;
storing an indication of the second type of role-based relationship between the first user and the second user, wherein the second type of role-based relationship exists simultaneously with the first type of role-based relationship;
selecting, from the plurality of elements, a second subset of elements that are associated with the second type of role-based relationship; and
providing, to the first client device, the second subset of elements.

19. The computer-readable medium of claim 15,
wherein providing the subset of elements to the first client device comprises initiating a live communication session between the first client device and a second client device associated with the second user.

20. A computer-implemented system, comprising:
one or more computers; and
one or more computer memory devices interoperably coupled with the one or more computers and having tangible, non-transitory, machine-readable media storing one or more instructions that, when executed by the one or more computers, cause the one or more computers to perform operations comprising:
storing a first association between a first user of a social network and a first role held by the first user, and storing a second association between a second user of the social network and a second role held by the second user, wherein the first role is different from the second role;
receiving a request to establish a first type of role-based relationship between the first user and the second user, wherein the first type of role-based relationship is specific to the first role and the second role;
storing an indication of the first type of role-based relationship between the first user and the second user;
querying a database storing a plurality of elements, wherein each element of the plurality of elements is associated with one or more types of role-based relationships that are specific to roles of users in the role-based relationships, and wherein the plurality of elements comprises at least one of user interface elements, application features, operations performable by client devices or requestable by client devices to be performed at a remote server, user images, user statistics, or protected user data, in which the querying includes selecting, from the plurality of elements, a subset of elements that are associated with the first type of role-based relationship; and
providing, to a first client device associated with the first user, the subset of elements, at least one of the subset of elements being for display in a graphical user interface of the first client device.

21. The computer-implemented system of claim 20, wherein the subset of elements comprises data associated with the second user, and wherein the first user is excluded from obtaining the data associated with the second user in the absence of the first type of role-based relationship.

22. The computer-implemented system of claim 20, wherein the operations comprise:
applying a trained image classification machine learning model to a set of images associated with the second user;
obtaining, as an output of the trained image classification machine learning model, image classification labels for images of the set of images; and
based on the image classification labels, storing an association between a first image of the set of images and the first type of role-based relationship,
wherein the subset of elements includes the first image.

23. The computer-implemented system of claim 20, wherein the operations comprise:
storing a third association between the first user of the social network and a third role held by the first user, wherein the first user holds the first role and the third role simultaneously;
receiving a request to establish a second type of role-based relationship between the first user and the second user, wherein the second type of role-based relationship is specific to the third role and the second role;
storing an indication of the second type of role-based relationship between the first user and the second user, wherein the second type of role-based relationship exists simultaneously with the first type of role-based relationship;
selecting, from the plurality of elements, a second subset of elements that are associated with the second type of role-based relationship; and
providing, to the first client device, the second subset of elements.

24. The computer-implemented system of claim 20,
wherein providing the subset of elements to the first client device comprises initiating a live communication session between the first client device and a second client device associated with the second user.

25. A computer-implemented method, comprising:
storing data indicating a first relationship between a first user of a social network and a second user of the social network;
receiving a request to substitute a third user of the social network for the first user in the first relationship;
receiving, from at least one of a second client device associated with the second user and a third client device associated with the third user, at least one corresponding approval of the request; and
in response to receiving the at least one corresponding approval, storing data indicating a second relationship between the second user and the third user.

26. The computer-implemented method of claim 25, wherein storing the data indicating the second relationship comprises initiating the second relationship at a stage matching a latest stage of the first relationship.

27. The computer-implemented method of claim 26, wherein the latest stage of the first relationship comprises an initial stage, and wherein the method comprises:
providing, to the second client device, a user interface configured to be used to approve or disapprove the second user.

28. The computer-implemented method of claim 26, wherein the latest stage of the first relationship comprises an approved stage, and wherein the method comprises at least one of:
enabling network communications between the second user and the third user, or
providing, to the second client device associated with the second user, private data of the third user that is inaccessible to the second user in the absence of an approved match between the second user and the third user.

29. The computer-implemented method of claim 26, wherein the method comprises enabling the network communications between the second user and the third user, and wherein the network communications comprise live video communication.

30. The computer-implemented method of claim 25, comprising:
in response to receiving the at least one corresponding approval, storing data indicating a cancellation of the first relationship.

31. The computer-implemented method of claim 25, wherein the first relationship comprises a first role-based relationship specific to a first role held by the first user and a second role held by the second user, and wherein the method comprises, prior to receiving the request to substitute the third user:
querying a database storing a plurality of users, wherein each user of the plurality of users is associated with one or more respective roles held by the user, and wherein the querying includes selecting, from the plurality of users, a subset of users that hold the first role; and
providing for selection, to a first client device associated with the first user, the subset of users.
